(19) United States
(12) Patent Application Publication
(10) Pub. No.: US 2018/0114527 A1
(43) Pub. Date: Apr. 26, 2018

(54) METHODS AND SYSTEMS FOR VIRTUAL AGENTS

(71) Applicant: IPsoft Incorporated, New York, NY (US)

(72) Inventors: Ivan Alencar ZILOTTI, North Bergen, NJ (US); Chetan Dube, New York, NY (US)

(21) Appl. No.: 15/333,893

(22) Filed: Oct. 25, 2016

(51) Int. Cl. G10L 15/22; G06F 17/30; G10L 15/18

(52) U.S. Cl. CPC G10L 15/22; G10L 2015/223; G10L 15/18; G06F 17/30598

(57) ABSTRACT

A method for creating a process network for use by virtual agent is provided. A plurality of dialogues between one or more users and one or more agents can be monitored. The dialogues can converted into one or more processes. The processes can be grouped and merged. The processes can be executed by a virtual agent.

The invention relates generally to cognitive computing systems including virtual agents. In particular, the invention relates to process learning, process consolidation, and/or process execution by cognitive computing systems.

### BACKGROUND

Current cognitive computing systems can include systems that can execute processes, mine data, perform pattern recognition and/or natural language processing. Many cognitive computing systems include a virtual agent that can be implemented to have outputs that appear similar to humans. For example, cognitive computing systems can include displaying on a screen a virtual agent via an avatar. The avatar can appear to be talking and interact with a user (e.g., human user) by, for example, using natural language to ask/answer questions and respond to the user's input. The virtual agent can use natural language processing to transform natural language input (e.g., phrases and/or words) by the user into a form that can be processed by the virtual agent (e.g., a computer).

The cognitive computing system can assist a user by executing a process. For example, the cognitive computing system can execute a series of predefined steps to solve a problem stated by user. In typical cognitive computing systems, the system obtains new processes by user input. These processes are typically not natural language processes, but are processes that can be execute by a computer. In these current systems, virtual agents can interact with a user by outputting questions and/or receiving user input. Once the virtual agent receives the user input, the virtual agent can execute the corresponding pre-programmed process. These current systems typically can't allow for the process and interaction to occur at the same time, because, for example, natural language inputs received by the system during process execution are typically not understandable by the system.

One difficulty with current system can be an amount of storage and traversing necessary to store and find all of the processes to be executed. For example, for a virtual agent that performs IT services, the number of processes to store can be prohibitively large.

Another difficult with current systems is that a number of steps typically necessary to traverse the stored processes and/or execute the processes can take more than a desired amount of time. For example, a user can experience delays that are beyond delays typically expected by a user.

Another difficulty with current cognitive computing systems that rely on identifying known phrases can be that the number of phrases a system needs to know to be able to handle any input by a user may not be practically implementable, as every potential input by a user may not be predictable. Another difficult with current cognitive computing systems is that pre-programmed processes can fail is there is unexpected input or an unexpected request.

Therefore, it can be desirable to have a cognitive computing system that allows a fewer number or processes and/or steps to enhance a user experience. It can also be desirable for a system that accounts for unexpected input and/or unexpected request. It can also be desirable for a system that provides simultaneous process execution and user interaction. It can also be desirable for a system that can acquire (e.g., learn) new processes based on natural language dialogues.

### SUMMARY OF EMBODIMENTS OF THE INVENTION

One advantage of the invention is that it can allow a fewer number or processes and/or steps to enhance a user experience. Another advantage of the invention is that it can account for unexpected input and/or unexpected request. Another advantage of the invention is that it can provide simultaneous process execution and user interaction. Another advantage of the invention is that it can acquire (e.g., learn) new processes based on natural language dialogues. Another advantage of the invention is that it can reduce redundancies among processes.

Another advantage of the invention is that it can reliable and repeatably learn processes after one observance of a dialogue, beyond what is capable by a human agent. Another advantage of the invention is that it can merge processes such that neither of the processes being merged has tasks and/or metadata necessary for process execution that is lost. Another advantage of the invention is that it can merge a large number of processes (e.g., hundreds, thousands, or more).

In one aspect, the invention involves a method for creating a process network for use by virtual agent. The method involves monitoring a plurality of dialogues between one or more users and one or more agents, each dialogue of the plurality of dialogues comprising one or more utterances. The method also involves creating a plurality of processes by creating one process to correspond to each dialogue of the plurality of dialogues, the one process based on the one or more utterances of each corresponding dialogue. The method also involves grouping the plurality of processes based on similarity between the plurality of processes to create a plurality of process groups. The method also involves merging the plurality of process groups to create a process network.

In some embodiments, the monitoring is by the virtual agent. In some embodiments, the agent is a human agent, another virtual agent, a computer, or any combination thereof. In some embodiments, the user is a human user, another virtual agent, a computer, or any combination thereof.

In some embodiments, creating the one process further comprises receiving one or more utterances that correspond to a current dialogue and for each utterance of the one or more utterances that correspond to the current dialogue and that are from a corresponding agent of the one or more agents: i) transforming a current utterance into a task, the task having a task action, ii) assigning the task a last utterance by a corresponding user of the one or more users if the last utterance exists, wherein the last utterance is a previous utterance of the corresponding user, iii) if a previous task exists in the one process, coupling the task to the previous task, and iv) adding the task and its assigned last utterance to the one process.

In some embodiments, the method further comprises for each utterance of the one or more utterances that corresponds to the current dialogue and that are from the corresponding user of the one or more users, determining if a last task was uttered by the virtual agent, and if the last task was not uttered by the virtual agent, then a) creating a new silent task, b) assigning the new silent task a current utterance of the one or more utterances, c) if a previous task exists, coupling the new task to a previous task and d) adding the new task and its assigned current utterance to the one process.

In some embodiments, the method further comprises appending the one process onto another stored process if the current dialogue was initiated as a result of the virtual agent failing to complete the stored process during execution of the stored process.

In some embodiments, the dialogue is cellular phone communication, text messages, computer inputs or any combination thereof. In some embodiments, transforming the current utterance into a task is based on whether the current utterance is interrogative, a command, or neither. In some embodiments, the task action is ask, say, run or stay silent.

In some embodiments, grouping the plurality of processes further comprises, determining a set of unique process pairs based the plurality of processes, removing pairs from the set of unique process pairs where both members of the pair are the same to create a unique and disjoint set of process pairs, for each pair from the set of unique and disjoint set of process pairs, determine a similarity score between the processes in each pair, removing each process pair in the set of unique and disjoint process pairs that have a similarity score value below a threshold to create a set of similar process pairs, and for each process pair in the set of similar process pairs, create a group of all other process pairs in the set of similar process pairs that are transitive to the current process pair and add the group the plurality of process groups.

In some embodiments, merging the plurality of process groups further comprises a) for each process group in the plurality of process groups, b) determining all unique and disjoint pairs, and c) merging a current process group with each of the unique and disjoint pairs to create a merged group, d) deleting the current process group and adding the merged group to the plurality of current process groups, and recursively executing steps a through c until there is only a single group in the plurality of current process groups to create the process network.

In some embodiments, the method involves a virtual agent to assist a user. In some embodiments, receiving, by the virtual agent, an utterance from the user, determining, by the virtual agent, a process to execute from a plurality of stored processes based on an intent of the utterance, wherein each process in the plurality of processes comprises one or more tasks, wherein each of the one or more tasks comprises a task action type and an order number, wherein the order number indicates an order in which the respective task is to be executed relative to other tasks in the one or more tasks, for each of the one or more tasks in the process to execute, in an order indicated by the order number, determining, by the virtual agent, whether to output a statement or a question to a user, switch to another process of the one or more processes or to transfer the user to a human agent based on a task action type of the respective task.

In some embodiments, if is determined to output a question to the user, the method further comprises, receiving, by the virtual agent, a response from a user, and determining, by the virtual agent, whether the virtual agent can handle the response based on comparing the response to responses expected in the respective process.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a system diagram for creating and/or executing a process network, according to an illustrative embodiment of the invention.

FIG. 2 is a flow diagram of a method for a cognitive computing system to create a process network for use by the cognitive computing system, according to an illustrative embodiment of the invention.

FIG. 3 is a flow diagram of a method for creating a process of a process network, according to an illustrative embodiment of the invention.

FIG. 3a is an example of a process determined via the method of FIG. 3, according to an illustrative embodiment of the invention.

FIG. 3b is an example of a processed determined via the method of FIG. 3, according to an illustrative embodiment of the invention.

FIG. 4 is a flow diagram of a method for grouping a plurality of processes, according to an illustrative embodiment of the invention.

FIG. 4a is an example of a process determined via the method of FIG. 4, according to an illustrative embodiment of the invention.

FIG. 4b is an example of grouping a plurality of processes via the method of FIG. 4, according to an illustrative embodiment of the invention.

FIG. 4c is an example of a grouping of a plurality of processes via the method of FIG. 4, according to an illustrative embodiment of the invention.

FIG. 5 is a flow diagram of a method for merging a plurality of processes, according to an illustrative embodiment of the invention.

FIG. 5a is an example of a grouping a plurality of processes via the method of FIG. 5, according to an illustrative embodiment of the invention.

FIG. 5b is an example of a grouping a plurality of processes via the method of FIG. 5, according to an illustrative embodiment of the invention.

FIG. 5c is an example of a grouping a plurality of processes via the method of FIG. 5, according to an illustrative embodiment of the invention.

FIG. 6 is a flow diagram of a method for a virtual agent to assist a user, according to an illustrative embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In general, a cognitive computing system having a virtual agent can learn processes from natural language dialogues. The processes can be grouped and/or merged with existing processes or other new/learned processes. The cognitive computing system can learn any process related to any subject. The virtual agent can use the processes to interact and execute tasks for a user. The virtual agent can interact with the user using natural language processes, even when the virtual agent is executing processes.

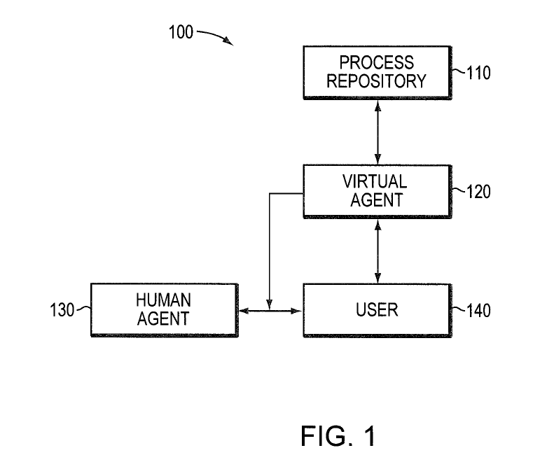

FIG. 1 is a system diagram 100 for creating and/or executing a process network, according to an illustrative embodiment of the invention. The system 100 includes a virtual agent 120, a process repository 110, and a user 140. A human agent 130 can interact with the system 100. The virtual agent 120 can communicate with the user 140 and/or the process repository 110.

The virtual agent 120 can also monitor interaction between the human agent 130 and the user 140. The virtual agent 120 can create new processes (e.g., learn) based on the interaction between the human agent 130 and the user 140. The virtual agent 120 can store the new processes in the process repository 110.

The virtual agent 120 can execute processes stored in the process repository 110. The virtual agent 120 can be any suitable computing or computation device that can carry out the methods described herein.

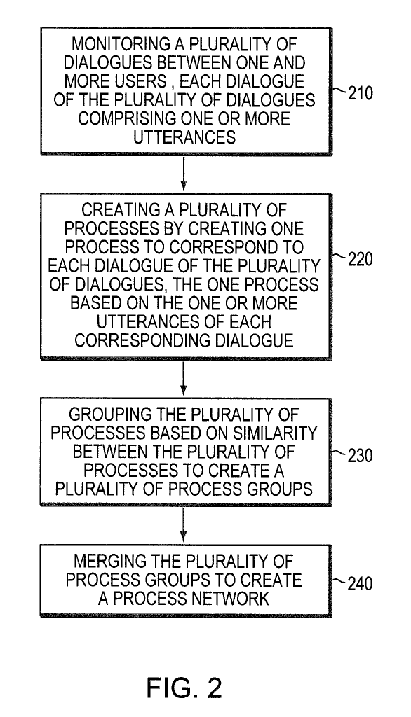

FIG. 2 is a flow diagram of a method 200 for a cognitive computing system to create a process network for use by the cognitive computing system, according to an illustrative embodiment of the invention.

The method involves monitoring a plurality of dialogues between one or more users and one or more agents, each dialogue of the plurality of dialogues can include one or more utterances (Step 210). The monitoring can be by a virtual agent of the cognitive computing system.

The plurality of dialogues can include requests by a user for an agent to execute actions for the user. For example, a user can have a dialogue with an agent for ordering a pizza for deliver, modifying computer access for users of an enterprise network, booking plane tickets, obtain banking information, set cell phone requirements, and/or any type of conversation between a user and an agent where the agent is assisting the user, executing a process on behalf of a user, and/or interacting with a user.

In various embodiments, the user is a human user, another virtual agent, another virtual user, a computer, or any combination thereof. In some embodiments, the agent is a human agent, another virtual agent, a computer, or any combination thereof.

In some embodiments, the dialogue is a recording of a verbal conversation. In some embodiments, the dialogue is an email chain. In some embodiments, the dialogue is a text message. As is apparent to one of ordinary skill, the dialogue can be any dialogue that is captured and processed by a computing device.

In some embodiments, a dialogue between a user and an agent can start with the user being one type of user and the agent being another type of user, and during the dialogue, the type of user and/or agent can switch. For example, a dialogue between a human user and a virtual agent, can switch mid-dialogue to being between the human user and a human agent. As is apparent to one of ordinary skill in the art, the foregoing user/agent example is just one example, and that other combinations of user/agents are within the scope of the invention.

For example, Table 1 shown below is an example of a first dialogue that starts between a human user and a virtual agent, and switches to being between the human user and a human agent.

TABLE 1

| | |
|---|---|
| 1- | Virtual Agent: Hello! |
| 2- | User: Bring me coffee |
| 3- | Virtual Agent: Please be on hold for one second |
| | while I contact an agent to help you. |
| 4- | Human Agent: What coffee would you like? ← Human |
| | agent picked up the escalated conversation. Learning starts. |
| 5- | User: Macchiato |
| 6- | Human Agent: Hot or iced? |
| 7- | User: Hot, please |
| 8- | Human Agent: Okay, your hot macchiato will be ready in |
| | two minutes. |
| 9- | Human Agent: Here it is! |
| 10- | Human Agent: How else may I help you? |
| 11- | User: That's it |
| 12- | Human Agent: Okay, have a lovely day! |

Table 1 shows a total of twelve utterances. In some embodiments, a dialogue to be learned can start when a dialogue switches from a virtual agent and a human agent. For example, in Table 1 utterances 1 through 3 can be excluded from the first dialogue. The first dialogue can include utterances 4 through 12. In some embodiments, utterances 1 through 12 are included in the first dialogue. In some embodiments, if the virtual agent learning the process is different from the virtual agent that is having the dialogue, then the utterances 1 through 3 can be included in the dialogue to be learned. For example, in some embodiments, the virtual agent in the dialogue shown in Table 1 is a third party virtual agent that the cognitive computing system can learn from.

Table 2 shown below is an example of a second dialogue that starts between a human user and a virtual agent, and switches to being between the human user and a human agent.

TABLE 2

| | |
|---|---|
| 1- | Virtual Agent: Hello! |
| 2- | User: Bring me coffee |
| 3- | Virtual Agent: What coffee would you like today? |
| 4- | User: Cappuccino |
| 5- | Virtual Agent: I only know how to prepare Macchiato. Please hold . . . |
| 6- | Human Agent: Hold on while I prepare you a cappuccino . . . ← |
| | Human agent picked up conversation. Learning starts. |
| 7- | Human Agent: Here it is! |
| 8- | User: OK |
| 9- | Human Agent: How else may I help you? |
| 10- | User: I'm good |
| 11- | Human Agent: Sure! Goodbye |

As shown in Table 2, utterance 6 is the utterance that escalation to a human agent occurs. In some embodiments, utterances 6 through 11 are included in the second dialogue. In some embodiments, utterances 1 through 11 are included in the second dialogue.

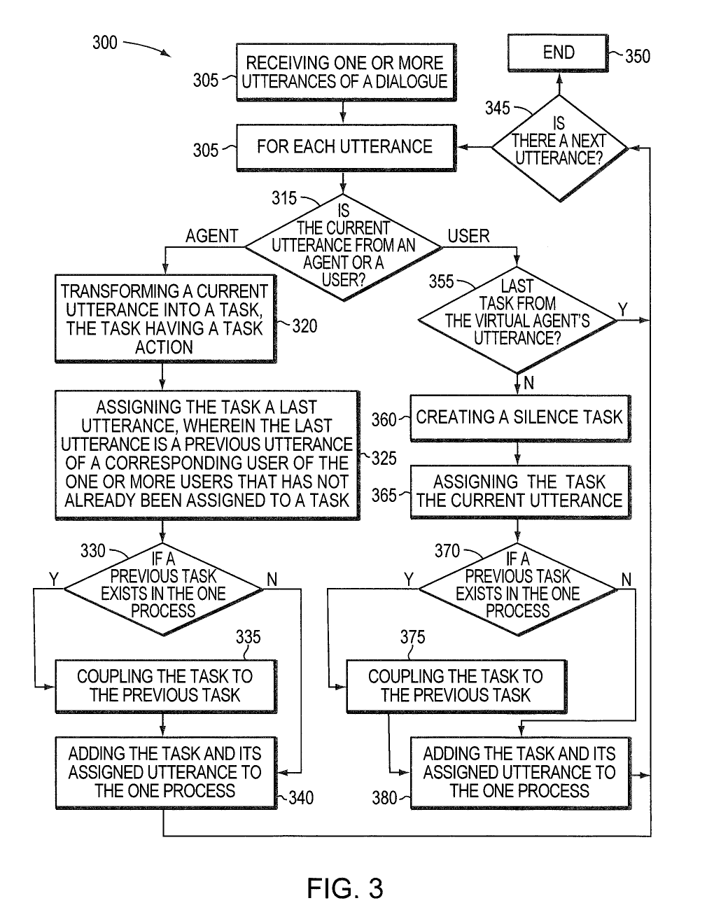

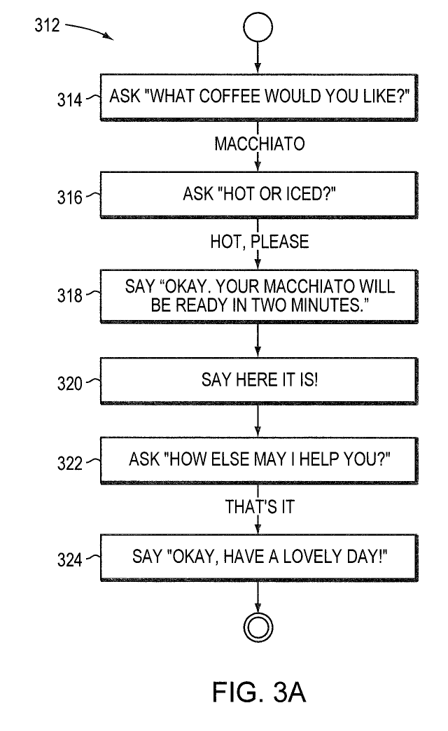

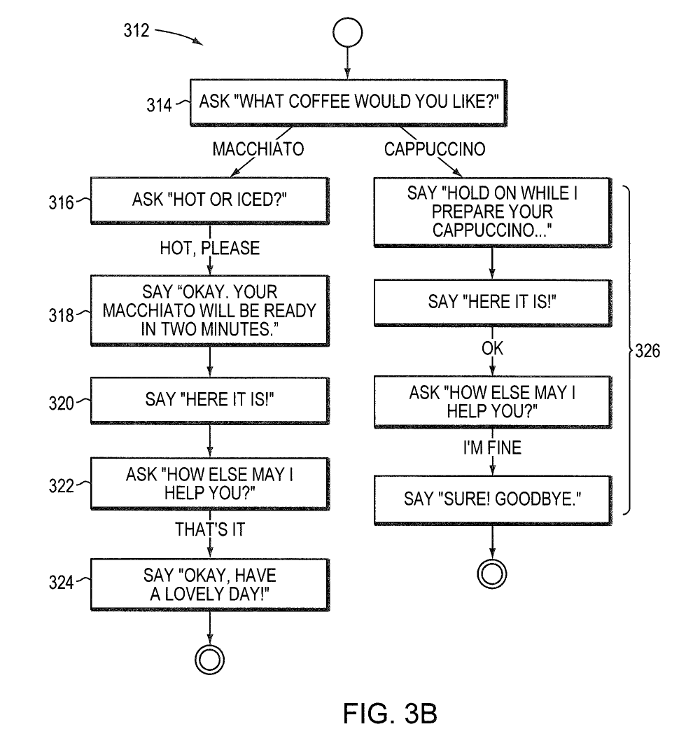

The method also involves creating a plurality of processes by creating one process to correspond to each dialogue of the plurality of dialogues, the one process based on the one or more utterances of each corresponding dialogue (Step 220). For example, a dialogue between a user of the one or more users with an agent of the one or more agents can include a dialogue start and a dialogue end and have a plurality of utterances. Each utterance can be from either the user or the agent. Each utterance in the dialogue can be used to create the one process. In some embodiments, the one process is determined as described below in FIG. 3.

The method also involves grouping the plurality of processes based on similarity between the plurality of processes to create a plurality of process groups (Step 230). Processes in the plurality of processes can be grouped together if they have a high degree of similarity. For example, processes that share identical and/or highly similar fragments can be grouped together.

In some embodiments, the grouping is based on geometry of the process graph. For example, when the process is represented as a process graph, the geometry of the process graph can indicate the order in which tasks (e.g., nodes of the process graph) are executed. Two process graphs can be sufficiently similar for grouping if they have similar branches off of a fork in the graph and/or join of the same type. In some embodiments, the grouping is done based on one or more process graph attributes (e.g., content of text in a process step, name, and/or description). In some embodiments, the grouping is done based on one or more task attributes (e.g., expected answer types). In some embodiments, the grouping is based on one or more tasks of the plurality of processes. In some embodiments, the grouping is based on intents that historically led to the execution of the process. In some embodiments, the grouping is based on intent of the user during the dialogue.

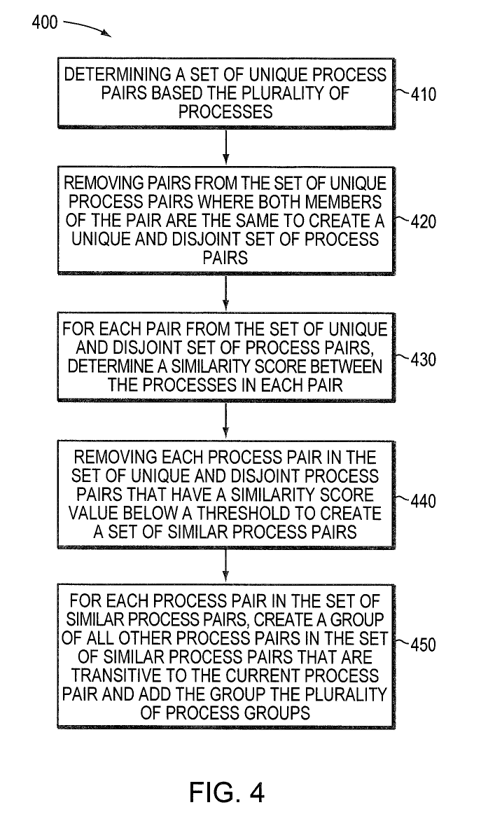

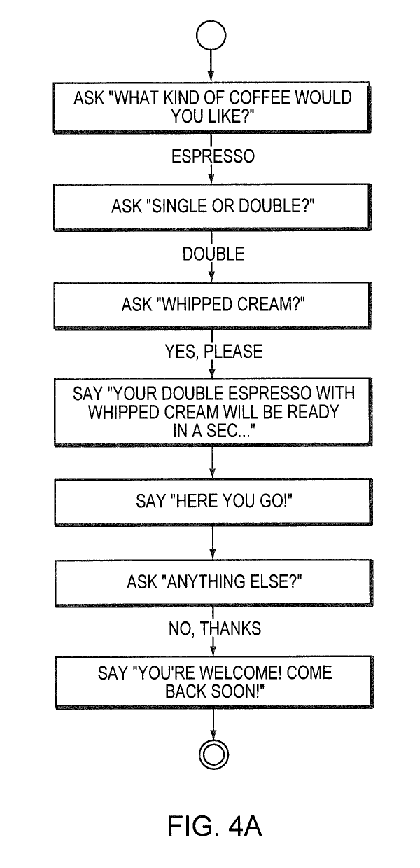

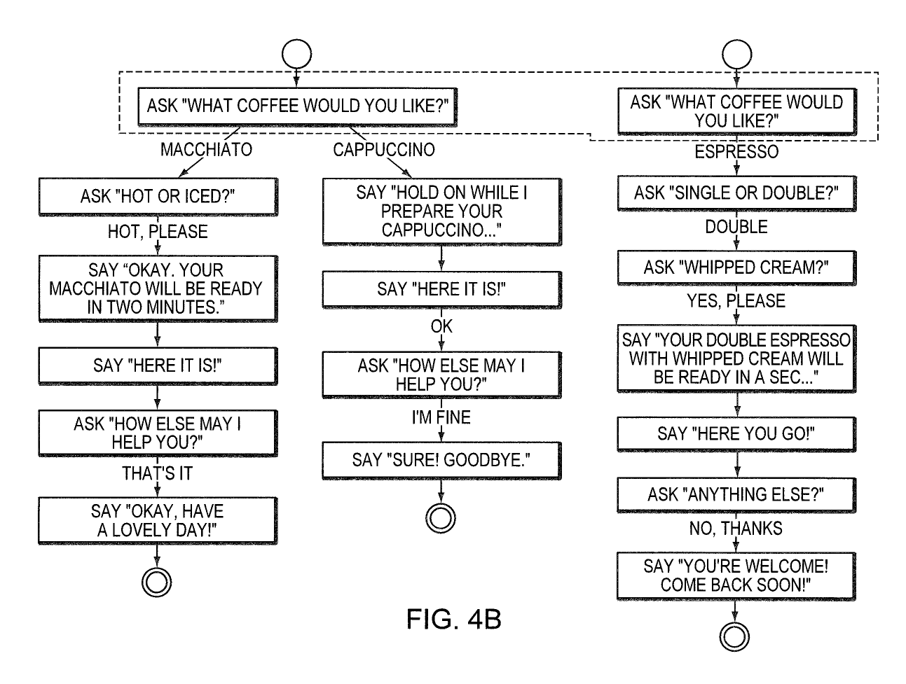

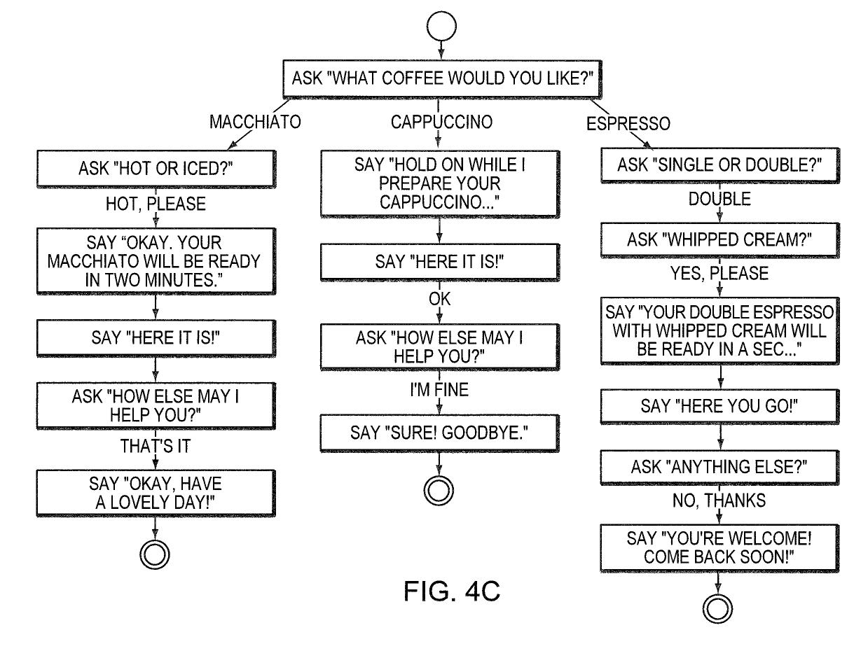

In some embodiments, the grouping is determined as is described below in FIG. 4.

The method also involves merging the plurality of process groups to create a process network (Step 240). The merging can allow for consolidation of the plurality of processes. In this manner, an amount of process data needed to be stored and traversed through to execute a process can be significantly reduced. Reducing the amount of process data can allow a virtual agent to respond to a human user within an amount of time that is as fast, or even faster than a human agent typically takes to respond. In this manner, the human user can have an experience interacting with a virtual agent executing the merged process that is better than an experience the human user has with a human agent.

FIG. 3 is a flow diagram of a method 300 for creating a process of a process network, according to an illustrative embodiment of the invention.

The method involves receiving one or more utterances of a dialogue (e.g., a dialogue from the plurality of dialogues as described above in FIG. 2) (Step 305). In some embodiments, all words uttered up to a change in the utterer (e.g., the agent or the user) are put together in one utterance. For example, assume the following dialogue:
User (01/30/2016 11:25 AM): Hi
Agent (01/30/2016 11:26 AM): Hello
User (01/30/2016 11:26 AM): I need help with my policy.
Agent (01/30/2016 11:27 AM): Auto or Homeowners?
User: HO

As can be seen in the dialogue, there is a change in utterer after the word “Hi,” from the user to the agent; there is a change in utterer after the word “Agent,” from the agent to the user; there is a change in utterer after the words “I need help with my policy,” from the user to the agent; there is a change in utterer after the words “Auto or Homeowners” from the agent to the user. In the above dialogue, there are five utterances. The first utterance is “Hi”; the second utterance is “Hello”; the third utterance is “I need help with my policy”; the fourth utterance is “Auto or Homeowners”; and the fifth utterance is “HO.”

In various embodiments, delineating the one or more utterances of the dialogue is based on a time stamp and/or date of the utterance.

The method also involves, for each utterance (Step 310), determining if the current utterance is from a user or an agent (Step 315). The determination can be based on a role of the utterer (e.g., agent or user), time of the utterance, and/or contents of the utterance. In some embodiments, the determination is based on a communication channel of the utterance. For example, utterances that are received from a cell phone can be from the user.

If the current utterance is from the agent, the method involves transforming the current utterance into a task (Step 320). The task can include a task action. The current utterance can be transformed into a task by determining whether the current utterance is an interrogative sentence, an agent command, or neither. If the current utterance is an interrogative sentence, then the current utterance can be transformed into an “ask” task. If the current utterance is an agent command, then the current utterance can be transformed into a “run” task. If the current utterance is neither an interrogative sentence or an agent command, then the current utterance can be transformed into a “say” tasks.

In some embodiments, whether the current utterance is determined to be an interrogative sentence or an agent command is based on content of the current utterance. For example, if the virtual agent's name is Mary, an example of an agent command is “Mary, as what is your name.”

The method also involves assigning the task a last utterance by a corresponding user of the one or more users (Step 325). The last utterance can be a previous utterance of the corresponding user.

The method also involves determining if a previous task exists in the one process. (Step 330). If a previous task exists, then coupling the task to the previous task (Step 335).

The method also involves adding the task and its assigned utterance to the one process (Step 340). The method also involves determining if there is a next utterance in the one or more utterances (Step 345). If there is a next utterance, then the method also involves returning to Step 310. Otherwise, the method involves ending the method (Step 350).

If the current utterance if from the user, the method also involves determining if a last task executed was by the virtual agent (Step 355). If the last task executed was by the virtual agent, then the method also involves returning to Step 345. If the last task executed was not by the virtual agent, then the method also involves creating a silence task (Step 360) and assigning the silence task the current utterance (Step 365).

The method also involves determining if a previous task exists in the one process. (Step 370). If a previous task exists, then coupling the task to the previous task (Step 375).

The method also involves adding the task and its assigned utterance to the one process (Step 380). The method also involves determining if there is a next utterance in the one or more utterances (Step 345). If there is a next utterance, then the method also involves returning to Step 310. Otherwise, the method involves ending the method (Step 350).

In some embodiments, a process graph is constructed from the method of FIG. 3. In these embodiments, each task can be assigned a node and each user utterance can be assigned an edge. In these embodiments, under certain conditions nodes and/or edges can be empty. For example, if the agent utters twice before the user has an utterance, the edge between the two agent utterances can be empty (e.g., no text is assigned).

In some embodiments, each task that is created can have metadata assigned to the task. The metadata can be used by a virtual agent when executing the task. The metadata can be configurable. The metadata can include date, time, role, and/or behavior. In one example, tasks of action “ask” can have three behaviors which can determine how the virtual agent asks the question, if it already knows the answer. Namely, in this example, “confirm,” “ignore if responded,” and “always ask.”

FIG. 3a is an example of a process 312 determined via the method of FIG. 3 using the first dialogue as shown in Table 1 above as input. As shown above in Table 1, the first dialogue includes utterances 4 through 12. In accordance with the method of FIG. 3, one or more utterances of a dialogue, utterances 4 through 12 are received (Step 305 of FIG. 3). The first utterance, utterance 4 “what coffee would you like” is determined to be from an agent (Step 315 of FIG. 3).

Since utterance 4 is from the agent and an interrogative sentence, utterance 4 is transformed into a task 314 having an “ask” task action (Step 320 of FIG. 3). The “ask” task 314 can indicate when the virtual agent encounters ask action 314, the question “what coffee would you like” can be output to the user.

The “ask” task 314 is assigned last utterance of the user (Step 325 of FIG. 3), however, there is no utterance before learning starts with utterance 4, thus, the “ask” task 314 is not assigned an utterance. Since there is no previous task in the process 312 (Step 330 of FIG. 3), the “ask” task 314 is added to the process (Step 340 of FIG. 3).

It is determined that there is a next utterance (Step 345 of FIG. 3) after utterance 4. The next utterance, utterance 5 “macchiato” is determined to be from the user (Step 315 of FIG. 3), and the last task, utterance 4, is from the virtual agent (Step 355 of FIG. 3), thus the method proceeds to determine that there is a next utterance (Step 345 of FIG. 3).

The next utterance, utterance 6 “hot or iced” is determined to be from the agent. Since utterance 6 is from the agent and an interrogative sentence, utterance 6 is transformed into a task 316 having an “ask” task action (Step 320 of FIG. 3). The “ask” task 316 can indicate when the virtual agent encounters ask action 316, the question “hot or iced” can be output to the user.

The “ask” task 316 is assigned last utterance of the user (Step 325 of FIG. 3), utterance 5 “macchiato” that has not already been assigned to a different task. Next, because a previous task exists (task 314) (Step 330 of FIG. 3), task 316, and its assigned utterance, utterance 5 “macchiato” is coupled to the previous task (Step 335) and added to the process 312. Utterances 7 through 12 are also looped through using the method in FIG. 3, such that the process 312 is created. In this manner, a process can be learned by a virtual agent.

As is shown in FIG. 3a, each task in the process 312 can be a node with each task's corresponding assigned user utterance being an edge for the node. For tasks that do not have an assigned user utterance, the edge can be empty. In this manner, a process graph can be constructed.

FIG. 3b is an example of a virtual agent executing process 312 until escalation to a human agent, and then using the method of FIG. 3 to learn more steps for process 312 based on the second dialogue as shown above in Table 2. The virtual agent executes an “ask” task of process 312 corresponding to utterance 3 of the second dialogue by asking “what coffee would you like today.” In utterance 4, the user utters “cappuccino.” The virtual agent does not recognize the utterance “cappuccino” and responds with “I only know how to prepare cappuccino.” The second dialogue then switches to be between a human agent and the user. At utterance 6 is where the method of FIG. 3 begins. Executing the method of FIG. 3 on utterances 6 through 11 produces the process steps 326.

FIG. 4 is a flow diagram of a method 400 for grouping a plurality of processes (e.g., process 312 as described above in FIG. 3a, and process 412 as described below with respect to FIG. 4a), according to an illustrative embodiment of the invention. The method involves determining a set of unique process pairs based the plurality of processes (Step 410). For example, assume there are three processes, Process A, Process B, and Process C. In this example, the set of unique process pairs is {(A,A), (A,B), (A,C), (B,A), (B,B), (B,C) (C,A), C,B), (C,C)].

The method involves removing pairs from the set of unique process pairs where both members of the pair are the same to create a unique and disjoint set of process pairs (Step 420). Continuing with the example above, the unique and disjoint set of process pairs is {(A,B), (A,C), (B,C)}.

The method also involves, for each pair from the set of unique and disjoint set of process pairs, determine a similarity score between the processes in each pair (Step 430). In some embodiments, the similarity score is based on a graph similarity algorithm as is known in the art. For example, as shown in Dijkman et al. “Similarity of business process models: Metrics and evaluation. Inf. Syst. 36, 2 (April 2011), 498-516, and/or Aalst et al, “Process equivalence: comparing two process models based on observed behavior”, in Proceedings of the 4th international conference on Business Process Management (BPM'06), Schahram Dustdar, José Luiz Fiadeiro, and Amit P. Sheth (Eds.). Springer-Verlag, Berlin, Heidelberg, 129-144, both of which are incorporated herein by reference in their entireties.

In some embodiments, the similarity score is based on comparing a number of nodes and/or edges that are deleted during a previous merging.

The method also involves, removing each process pair in the set of unique and disjoint process pairs that have a similarity score value below a threshold to create a set of similar process pair (Step 440). For example, assume four processes, process a, process b, process c and process d. Assume the similarity scores for the four processes are as follows: {(a, b)=0.265; (a, c)=0.501; (a, d)=0.234; (a, e)=0.084; (b, c)=0.406; (b, d)=0.277; (b, e)=0.579; (c, d)=0.400; (c, e)=0.546; (d, e)=0.8321. Assume a threshold of 0.5, then the set of similar process pairs are {(a,e), (b,e), (c,e), and (d,e)}.

In some embodiments, the threshold is input by a user.

The method also involves, for each process pair in the set of similar process pairs, create a group of all other process pairs in the set of similar process pairs that are transitive to the current process pair and add the group the plurality of process groups (Step 450). For example, assume the set of similar process pairs is {(a,e), (b,e), (c,e), (d,e)}. Following with the similarity scores above, process e is similar to c, and process c is similar to a. Thus, process pair (a,e) has transitive similarity to process pair (c,e), such that process group (a, c, e) is added to the plurality of process groups. Continuing with the similarity scores above results in the plurality of process groups of {(c,a), (e,b), (a,e,c), (e,d), (b, c, d, e)}.

In some embodiments, redundancies across the plurality of process groups are eliminate. For example since (c,a) is in (a,e,c), the pair (c,a) can be eliminated. In these embodiments, continuing with the example above, the plurality of process groups is {(a,e,c), (b,c,d,e)}.

In various embodiments, the plurality of processes to be grouped are processes as learned via the method of FIG. 3, processes as programmed by a user, processes received from other computing systems or any combination thereof.

FIG. 4a is an example of a process 412 determined via the method of FIG. 3 using a third dialogue as shown in Table 3 below as input.

TABLE 3

| | |
|---|---|
| 1. | Virtual Agent: Hello! |
| 2. | User: Can you get me a cup of Joe? |
| 3. | Virtual Agent: Please be on hold for one second while |
| | I contact an agent to help you. |
| 4. | Human Agent: What kind of coffee would you like? |
| 5. | User: Espresso |
| 6. | Human Agent: Single or double? |
| 7. | User: Double |
| 8. | Human Agent: Whipped cream? |
| 9. | User: Yes, please. |
| 10. | Human Agent: Your double espresso with whipped |
| | cream will be ready in a sec . . . |
| 11. | Human Agent: Here you go! |
| 12. | User: Thanks |
| 13. | Human Agent: Anything else I can help you with? |
| 14. | User: No, thanks |
| 15. | Human Agent: You're welcome! Come back soon! |

As shown in Table 2, at utterance 2, the user asks “Can you get me a cup of Joe.” In this example, considering the dialogues shown in Table 1 and Table 2, the virtual agent does not recognize that “Can you get me a cup of Joe” is the same as “Bring me a coffee” of the dialogues in Table 1 and Table 2, and for which the processes are known. Thus, the virtual agent escalates to a human agent at utterance 3, and another process, the process shown in FIG. 4a is learned via the method of FIG. 3.

FIG. 4b is an example of grouping a plurality of processes, process 312 and 412 as described above, in accordance with the method of FIG. 4. As is shown in FIG. 4b, the via the method of FIG. 4, it is determined that “what coffee would you like” of process 312 and “what kind of coffee would you like” of process 412 are sufficiently similar that their respective processes can be grouped. FIG. 4c is an example of grouping a plurality of processes, process 312 and 412, according to the method of FIG. 4.

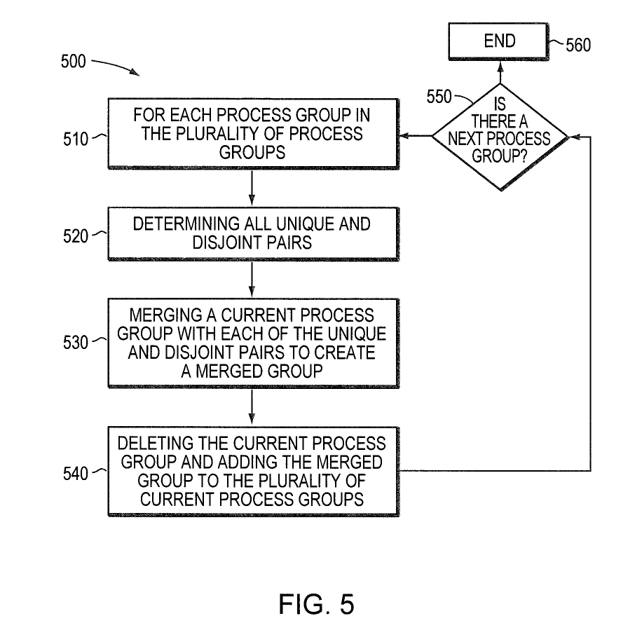

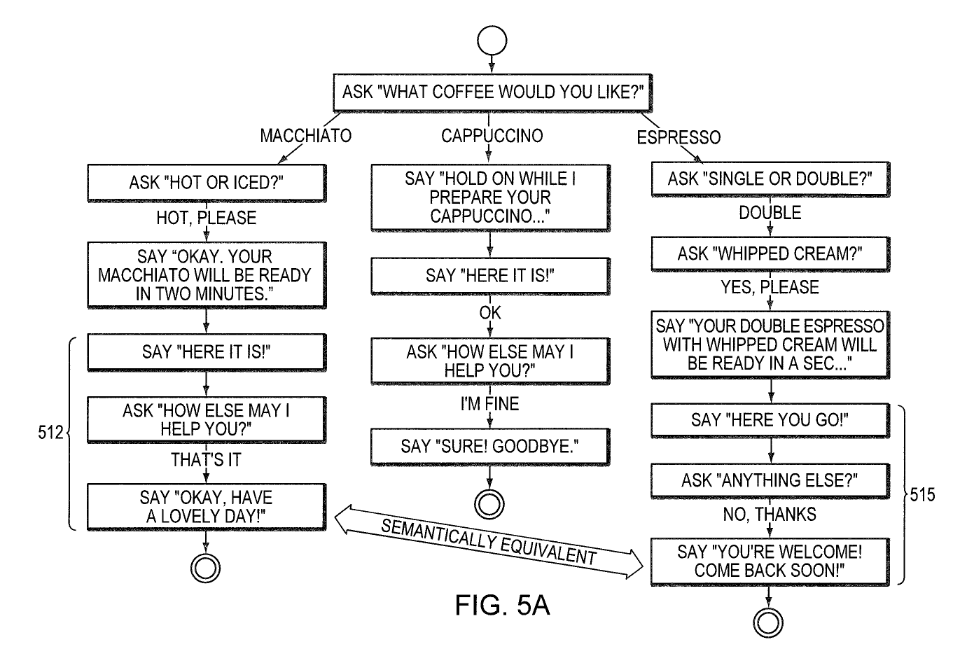

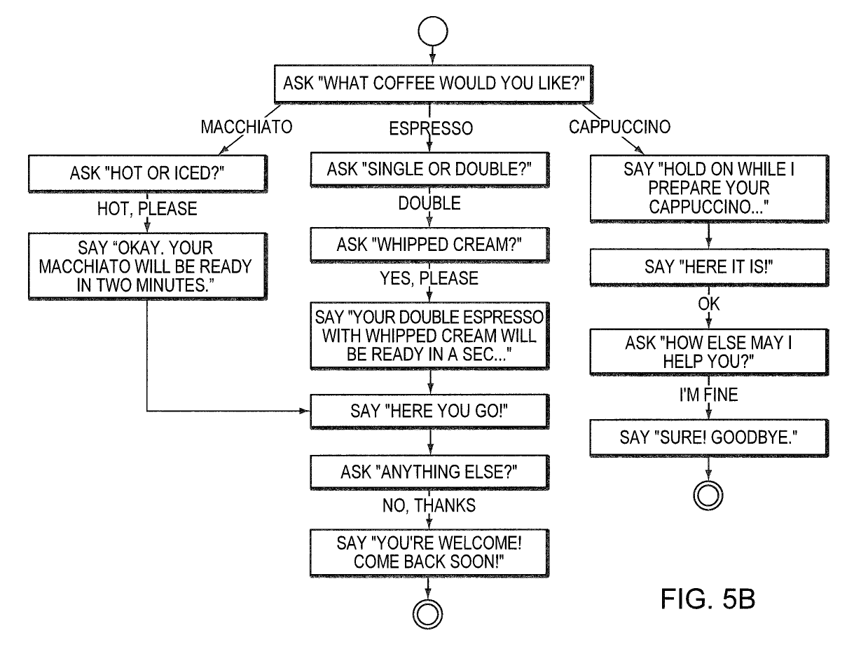

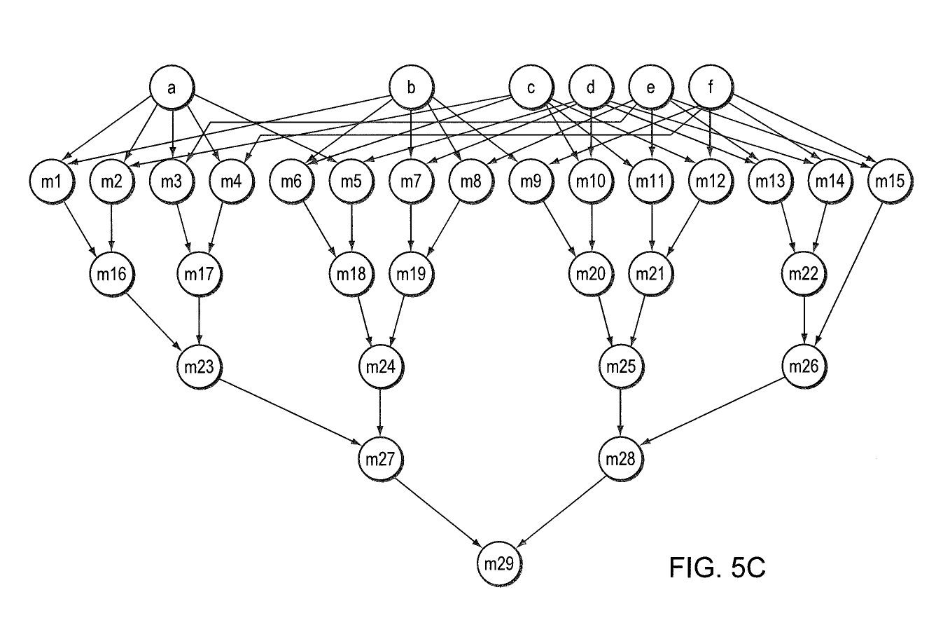

FIG. 5 is a flow diagram of a method 500 for merging a plurality of processes, according to an illustrative embodiment of the invention. The method involves for each process group in the plurality of process groups (Step 510), determining all unique and disjoint pairs (Step 520).

The method also involves merging a current process group with each of the unique and disjoint pairs to create a merged group (Step 530). In some embodiments, merging is done when tasks are determined to be the same (or substantially the same) or semantically similar. For example, two tasks can have different works “would you like coffee” and “can I get you a coffee”, but be semantically similar such that the tasks can merged into one task.

In some embodiments, merging is based on rules that operate on various type of flow control points (FCP) and/or constrained natural language expressions. For example. Exclusive FCP (XOR): XOR FCPs can either represent that after the task a choice has to be made about which path to continue on (split), or that the process has to wait for a single path to be completed before continuing (join). Tasks of the “ask” type are equivalent to split XOR FCPs, where the conditions are expressed in natural language. Inclusive FCP (OR): OR FCPs start or wait for multiple paths. Parallel FCP (AND): AND FCPs either represent that after the FCP (split) the process continues along multiple parallel paths, or that the FCP (join) must wait for all paths to finish.

The merging can be done as is known in the art. For example, Dijkman et al. 2011. “Similarity of business process models: Metrics and evaluation” Inf. Syst. 36, 2 (April 2011). 498-516, which is incorporate herein by reference it its entirety.

The method also involves deleting the current process group and adding the merged group to the plurality of current process groups (Step 540). The method also involves determining if there is a next process group in the plurality of process groups (Step 550). If there is a next process, then returning to Step 510. Otherwise, the method involves ending the method (Step 560).

In various embodiments, the plurality of processes to be merged are processes as learned via the method of FIG. 3, processes as programmed by a user, processes received from other computing systems or any combination thereof.

FIG. 5a is an example of merging a plurality of processes, according to an illustrative embodiment of the invention. Continuing with the grouped process shown in FIG. 4c, FIG. 5a shows the tasks, tasks 512 and 514 in the process of FIG. 4c that are similar sequences, such that they can be merged. FIG. 5b is an example of the process of FIG. 4c where tasks 512 and 514 are merged via the method of FIG. 5. As shown in FIG. 5b, there are fewer tasks in the merged process then were in the process pre-merging. In this manner, a number of tasks to store, traverse, and/or consider by the virtual agent (e.g., the computer) can be minimized.

FIG. 5c is an example of a process m29 determined via the method of FIG. 5 using process a, process b, process c, process d, process e, and process f. As is shown in FIG. 5a, process pairs are determined. For example, m1 includes process a and process e; m2 includes process c and e. Each intermediary merged pair, m1 through m15 is then merged again to create intermediary merges. The merging process can be performed recursively until there is on single merged process, m29.

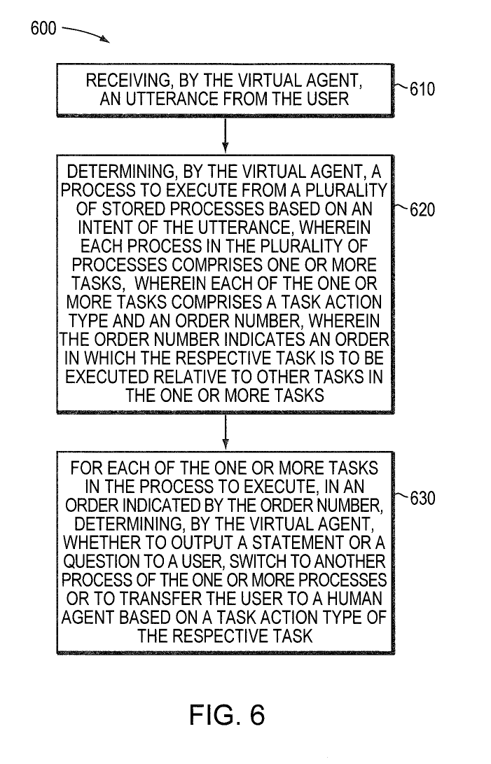

FIG. 6 is a flow diagram of a method 600 for a virtual agent to assist a user, according to an illustrative embodiment of the invention. The method involves receiving, by the virtual agent, an utterance from the user (Step 610).

The method also involves determining, by the virtual agent, a process to execute from a plurality of stored processes based on an intent of the utterance, wherein each process in the plurality of processes comprises one or more tasks, wherein each of the one or more tasks comprises a task action type and an order number, wherein the order number indicates an order in which the respective task is to be executed relative to other tasks in the one or more tasks (Step 620). The process to execute can be determined by determining a user's intent based on a first utterance of the user. For example, the intent of a user can be used to select a corresponding process from the plurality of processes that may satisfy the intent.

The plurality of stored processes can include newly learned processes, merged processes, or any combination thereof. For example, the plurality of stored processes can include processes 312, process 412, and/or merged process m29 as described above in FIG. 3a FIG. 4a, and FIG. 5a, respectively.

In some embodiments, the plurality of processes is serialized as XML, and can be stored in a database and/or in a filesystem. In these embodiments, the order number can be based on one or more process attributes of the serialized XML. In some embodiments, the order number indicates the connection between the one or more tasks in a process.

The method also involves for each of the one or more tasks in the process to execute, in an order indicated by the order number, determining, by the virtual agent, whether to output a statement or a question to a user, switch to another process of the one or more processes or to transfer the user to a human agent based on a task action type of the respective task (Step 630). For example, if a task is an “ask” task, then the virtual agent can output the task content to the user in the form of a question. When the user provides a response, the response can be compared to the stored user utterances (e.g., edges of a process graph). If there is a match, then the task associated with the matched user utterance (e.g., node connected to the edge of the process graph) can be executed.

The above-described methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed:

1. A method for creating a process network for use by virtual agent, the method comprising:
monitoring a plurality of dialogues between one or more users and one or more agents, each dialogue of the plurality of dialogues comprising one or more utterances;
creating a plurality of processes by creating one process to correspond to each dialogue of the plurality of dialogues, the one process based on the one or more utterances of each corresponding dialogue;
grouping the plurality of processes based on similarity between the plurality of processes to create a plurality of process groups; and
merging the plurality of process groups to create a process network.

2. The method of claim 1 wherein the monitoring is by the virtual agent.

3. The method of claim 1 wherein the agent is a human agent, another virtual agent, a computer, or any combination thereof.

4. The method of claim 1 wherein the user is a human user, another virtual agent, a computer, or any combination thereof.

5. The method of claim 1 wherein creating the one process further comprises:
receiving one or more utterances that correspond to a current dialogue;
for each utterance of the one or more utterances that correspond to the current dialogue and that are from a corresponding agent of the one or more agents:
transforming a current utterance into a task, the task having a task action,
assigning the task a last utterance by a corresponding user of the one or more users if the last utterance exists, wherein the last utterance is a previous utterance of the corresponding user,
if a previous task exists in the one process, coupling the task to the previous task, and
adding the task and its assigned last utterance to the one process.

6. The method of claim 5, further comprising for each utterance of the one or more utterances that corresponds to the current dialogue and that are from the corresponding user of the one or more users:
determining if a last task was uttered by the virtual agent, and
if the last task was not uttered by the virtual agent, then a) creating a new silent task, b) assigning the new silent task a current utterance of the one or more utterances, c) if a previous task exists, coupling the new task to a previous task and d) adding the new task and its assigned current utterance to the one process.

7. The method of claim 3 or 4 further comprising appending the one process onto another stored process if the current dialogue was initiated as a result of the virtual agent failing to complete the stored process during execution of the stored process.

8. The method of claim 3 wherein the dialogue is cellular phone communication, text messages, computer inputs or any combination thereof.

9. The method of claim 3, wherein transforming the current utterance into a task is based on whether the current utterance is interrogative, a command, or neither.

10. The method of claim 3 wherein the task action is ask, say, run or stay silent.

11. The method of claim 1 wherein grouping the plurality of processes further comprises,
determining a set of unique process pairs based the plurality of processes;
removing pairs from the set of unique process pairs where both members of the pair are the same to create a unique and disjoint set of process pairs;
for each pair from the set of unique and disjoint set of process pairs, determine a similarity score between the processes in each pair;
removing each process pair in the set of unique and disjoint process pairs that have a similarity score value below a threshold to create a set of similar process pairs; and
for each process pair in the set of similar process pairs, create a group of all other process pairs in the set of similar process pairs that are transitive to the current process pair and add the group the plurality of process groups.

12. The method of claim 1 wherein merging the plurality of process groups further comprises:
a) for each process group in the plurality of process groups:
b) determining all unique and disjoint pairs, and
c) merging a current process group with each of the unique and disjoint pairs to create a merged group,
d) deleting the current process group and adding the merged group to the plurality of current process groups; and
recursively executing steps a through c until there is only a single group in the plurality of current process groups to create the process network.

13. A method for a virtual agent to assist a user, the method comprising:
receiving, by the virtual agent, an utterance from the user;
determining, by the virtual agent, a process to execute from a plurality of stored processes based on an intent of the utterance, wherein each process in the plurality of processes comprises one or more tasks, wherein each of the one or more tasks comprises a task action type and an order number, wherein the order number indicates an order in which the respective task is to be executed relative to other tasks in the one or more tasks;
for each of the one or more tasks in the process to execute, in an order indicated by the order number, determining, by the virtual agent, whether to output a statement or a question to a user, switch to another process of the one or more processes or to transfer the user to a human agent based on a task action type of the respective task.

14. The method of claim 6 wherein if is determined to output a question to the user, the method further comprises:
receiving, by the virtual agent, a response from a user; and
determining, by the virtual agent, whether the virtual agent can handle the response based on comparing the response to responses expected in the respective process.
